(19) United States
(12) Patent Application Publication
(10) Pub. No.: US 2010/0072342 A1
(43) Pub. Date: Mar. 25, 2010

(54) RETRACTABLE SUPPORT AND DISPLAY HAVING THE SAME

(75) Inventors: Wen-Hung HUANG, Taipei County (TW); Guan-De Liou, Taipei City (TW); Stephen Tsai, Taipei County (TW)

Correspondence Address: RABIN & Berdo, PC, 1101 14TH STREET, NW, SUITE 500, WASHINGTON, DC, 20005, US

(73) Assignee: HANNSPREE, INC., Taipei City (TW)

(21) Appl. No.: 12/362,572

(22) Filed: Jan. 30, 2009

(30) Foreign Application Priority Data
Sep. 22, 2008 (TW) 097136374

(51) Int. Cl. F16M 11/38

(52) U.S. Cl. 248/434; 248/188.6

(57) ABSTRACT

A display having retractable support is provided which includes a body and two struts. The body has a display panel disposed on a front surface of the body. Moreover, the body has two chambers defined in the body and two openings respectively communicate the two chambers with the exterior of the body. Each of the struts is movably inserted into one of the chambers via the corresponding opening respectively, for being moved between a contained position and a support position by hands or by elastic members. When each strut is moved to the contained position, the strut is accommodated in the corresponding chamber. When each strut is move to the support position, at least one part of each strut is protruded out of the body for supporting the display above a placement plane.

### CROSS-REFERENCES TO RELATED APPLICATIONS

This non-provisional application claims priority under 35 U.S.C. § 119(a) on Patent Application No(s). 97136374 filed in Taiwan, R.O.C. on Sep. 9, 2008, the entire contents of which are hereby incorporated by reference.

### BACKGROUND OF THE INVENTION

1. Field of the Invention

The present invention relates to a display, and more particularly to a retractable support and a display using the same.

2. Related Art

A conventional display, especially a flat panel display, is placed on a placement plane (for example, a desk or a table) by a support. The support substantially includes a base and an arm. The base is placed on the placement plane for providing a stable support. The arm connects the display to the base, thereby supporting the display.

The base and the arm of the support for the conventional display are dismountable elements. When the display is transported, the support is separated from the base and the arm, and the base and the arm packaged respectively. Finally the packages of the base and the arm are combined with the package of the display to form an independent main package. Such package structure is rather complicated, which further results in wastes of the package materials. Furthermore, although the display is placed on the placement plane, a space below the display is occupied by the base, and as a result, computer peripherals, for example, a keyboard, cannot be stored or placed below the display. The keyboard is an input device that occupies the largest area, such that the utilization efficiency of the placement plane is reduced.

In R.O.C. (Taiwan) Patent No. I256576, a keyboard receiving and rejecting device is provided, in which a display is directly fixed on a base of a computer, and the base has an opening for accommodating the keyboard in the base. In U.S. Pat. No. 6,480,372, similarly, a display is disposed above a computer host, and a recessed keyboard holding portion is disposed in the host for accommodating a keyboard. In the above two patents, the computer host is mainly used as a support structure for the display and used to accommodate the keyboard. However, in the above two patents, the computer host needs to be placed on the placement plane together with the display, such that the computer host further occupies the placement plane.

In U.S. Pat. No. 7,126,814, a space-saver design for personal computer keyboard is provided, which is disposed on a back surface of the display. When the computer is not in use and the keyboard is no longer required, the keyboard is stored below and behind the display. However, in U.S. Pat. No. 7,126,814, the space between a position below and behind the display and the support structure is rather small, so that the keyboard must be configured into a flexible or foldable form, so as to pass through the space below the display and be fixed behind the display. In addition, in U.S. Pat. No. 7,126,814, during transportation, the support structure has to be dismounted into a plurality of components for being packaged individually, or a large-sized package structure is required, thereby resulting in wastes of package materials.

In U.S. Pat. No. 7,042,712, an extended stand computer system with a retractable keyboard is provided, in which the stand leans against the display after being folded or supports the display after being unfolded. The stand may support the display to an erection height, and the stand may form a surrounding disposition space on the placement plane behind the display, such that the keyboard is enabled to pass below the display and is accommodated in the disposition space. However, in order to make the stand lean against and flatly attach to the display, the erection height only allows the keyboard with a relatively small thickness to pass through, such that it is not suitable for various types of keyboards.

Therefore, it is still an important technical issue to solve the keyboard accommodation problem and prevent the keyboard from occupying the placement plane (on a desk) when the keyboard is not used.

### SUMMARY OF THE INVENTION

In view of the above problems, the present invention is directed to a retractable support and a display using the retractable support, suitable for reducing a cost of package materials and providing a keyboard accommodating function.

A display having a retractable support according to the present invention includes a body and two struts. The body has a display panel disposed on a front surface of the body. And the body further has two chambers defined in the body and two openings respectively communicate the two chambers with an exterior of the body. Each of the struts is movably inserted into one of the chambers via the corresponding opening respectively. The struts are provided for being or being moved between a contained position and a support position by hands or by elastic members. When each strut is moved to the contained position, the strut is accommodated in the corresponding chamber. When each strut is move to the support position, at least one part of each strut is protruded out of the body for supporting the display above a placement plane.

The advantage of the present invention is that the body is supported above the placement plane by the struts, such that the keyboard is enabled to be accommodated in a space below the body, thereby improving the utilization efficiency of the placement plane. In addition, the struts are combined with the body and can be contained in the body, such that the body does not have protruding or dismountable components disposed thereon. Therefore, when the display is transported, the package structure is greatly simplified, and the required package materials are significantly reduced.

### BRIEF DESCRIPTION OF THE DRAWINGS

The present invention will become more fully understood from the detailed description given herein below for illustration only, and thus is not limitative of the present invention, and wherein:

FIGS. 1 and 2 are perspective views of a first embodiment of the present invention;

FIG. 3 is a cross-sectional view of the first embodiment of the present invention;

FIGS. 4 and 5 are side views of the first embodiment of the present invention;

FIGS. 6 and 7 are partial cross-sectional views of the first embodiment of the present invention;

FIG. 8 is a front view of the first embodiment of the present invention;

FIG. 9 is a side view of the first embodiment of the present invention;

FIG. 10 is a cross-sectional view of a second embodiment of the present invention;

FIG. 11 is a cross-sectional view of the second embodiment of the present invention, obtained from another viewing angle;

FIGS. 12 and 13 are partial cross-sectional views of the second embodiment of the present invention;

FIG. 14 shows another using state of FIG. 11;

FIG. 15 is a side view of the second embodiment of the present invention;

FIG. 16 is a perspective view of a third embodiment of the present invention;

FIG. 17 is a cross-sectional view of the third embodiment of the present invention;

FIG. 18 is a partial cross-sectional view of the third embodiment of the present invention;

FIG. 19 shows another using state of FIG. 17; and

FIG. 20 shows another using state of FIG. 18.

### DETAILED DESCRIPTION OF THE INVENTION

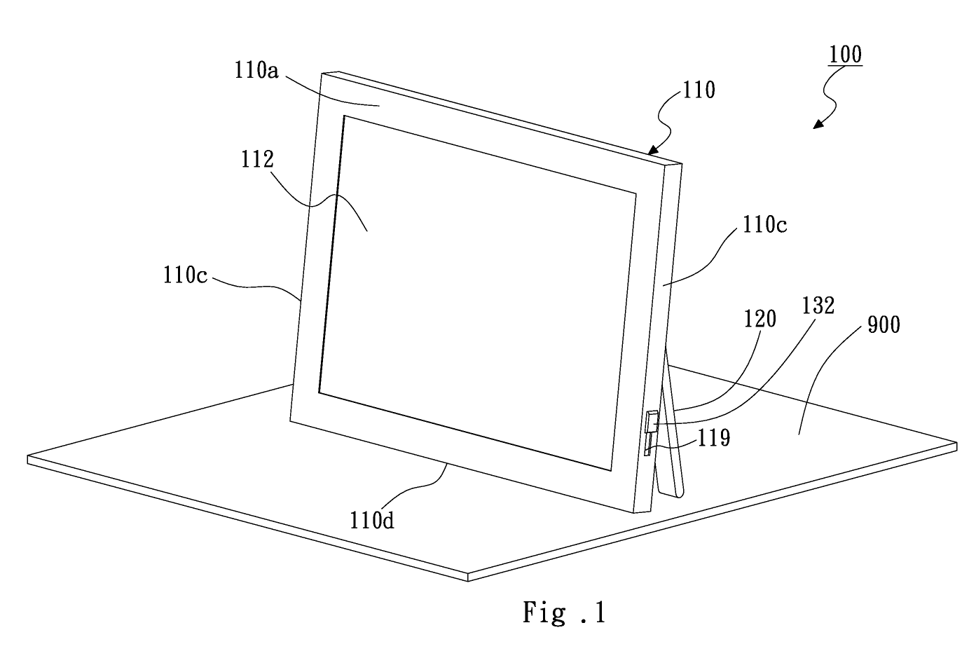

Referring to FIGS. 1, 2, and 3, a flat panel display 100 having a retractable support according to a first embodiment of the present invention is shown; the display 100 includes a body 110, a stand 120, and two struts 130.

Referring to FIGS. 1, 2, and 3, the body 110 has a display panel 112 disposed on a front surface 110a of the body 110, and has two chambers 114 defined in the body 110 and respectively corresponding to two opposite side edges 110c of the body 110. The body 110 further has two openings 116 disposed on a bottom edge 110d of the body 110, and two openings 116 respectively communicate the two chambers 114 with the exterior of the body 110.

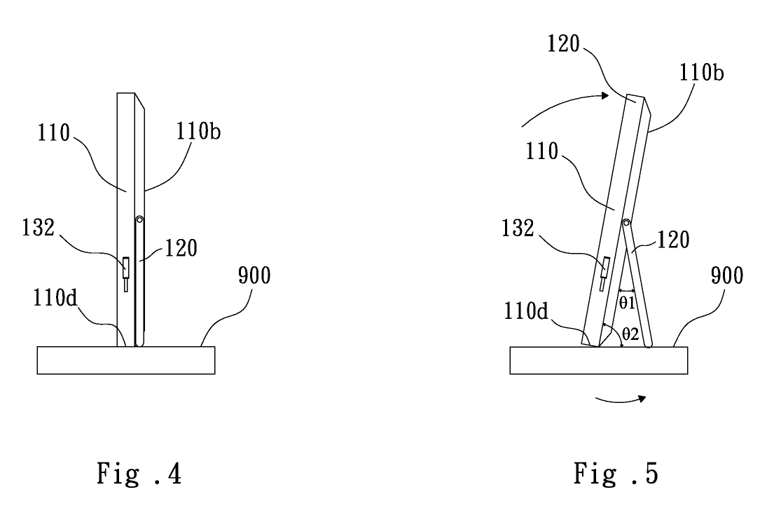

Referring to FIGS. 1, 4, and 5, the stand 120 is pivoted on a back surface 110b of the body 110 of the display 100. The stand 120 is provided for being rotated to form an included angle θ₁ (as shown in FIG. 5) with respect to the back surface 110b of the body 110 or leans against the body 110 to maintain an accommodation state (as shown in FIG. 4). When the included angle θ₁ is formed between the stand 120 and the back surface 110b of the body 110, a free end of the stand 120 may bears against a placement plane 900, and meanwhile, the bottom edge 110d of the body 110 also bears against the placement plane 900, such that the stand 120 together with the bottom edge 110d of the body 110 supports the body 110 above the placement plane 900, and the body 110 forms an inclined angle θ₂ with respect to the placement plane 900, in which the inclined angle θ₂ is used to match with a viewing angle of a user. In addition, the inclined angle θ₂ between the body 110 and the placement plane 900 is changed with the included angle θ₁ between the stand 120 and the body 110. The larger the included angle θ₁ between the stand 120 and the body 110 is, the larger the backward inclined angle of the body 110 is, such that the inclined angle θ₂ between the body 110 and the placement plane 900 is reduced. The smaller the included angle θ₁ between the stand 120 and the body 110 is, the smaller the backward inclined angle of the body 110 is, such that the inclined angle θ₂ between the body 110 and the placement plane 900 is increased.

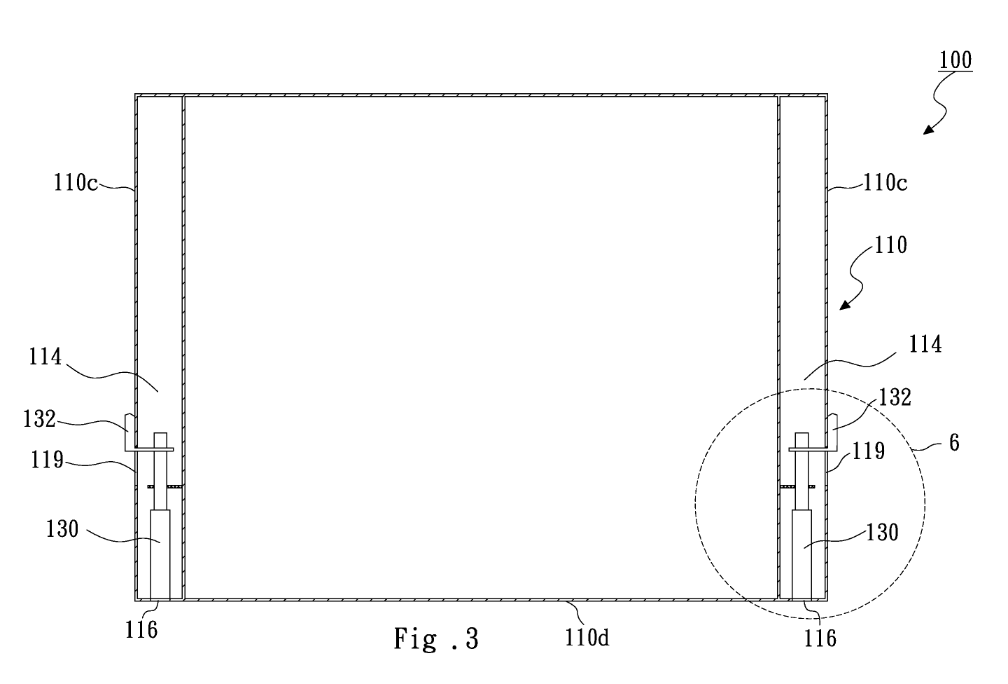

Referring to FIGS. 3, 6, and 7, each strut 130 is, for example, movably disposed in the body 110 in a tightly fitted manner. Each strut 130 is inserted into one of the two chambers 114 via the opening 116. Each strut 130 is moved between a contained position P1 and a support position P2. When each strut 130 is moved to the contained position P1, the strut 130 is accommodated in the corresponding chamber 114. When the strut 130 is moved to the support position P2, a part of the strut 130 is accommodated in the chamber 114, such that the strut 130 is maintained to be connected to the body 110, and the other part of the strut 130 is protruded out of the bottom edge 110d of the body 110 via the corresponding opening 116, thereby supporting the body 110. Thus, a supporting height D is formed between the bottom edge 110d of the body 110 and the placement plane 900.

Referring to FIGS. 3, 6, and 7, the body 110 includes two slots 119 formed thereon, each slot 119 is respectively formed on each side edge 110c of the body 110, and each slot 119 respectively communicates the two chambers 114 with the exterior of the body 110. Each strut 130 is connected to an operating portion 132 disposed on the side of the body 110. The operating portion 132 is connected to the corresponding strut 130 through the slot 119, and the operating portion 132 is provided for being manually operated by the user, such that the strut 130 is forced to move between the contained position P1 and the support position P2.

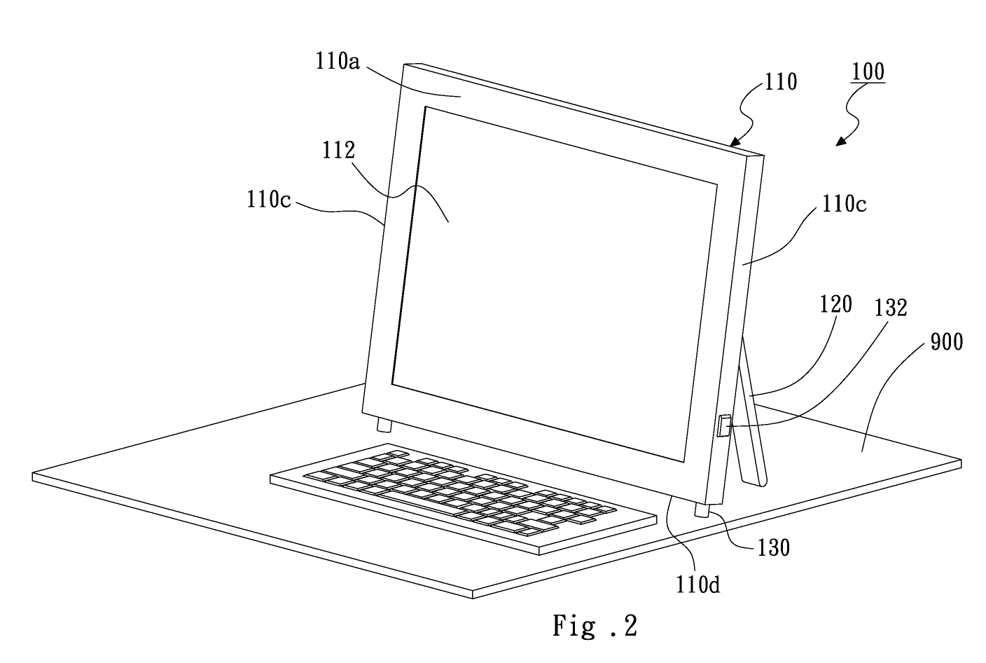

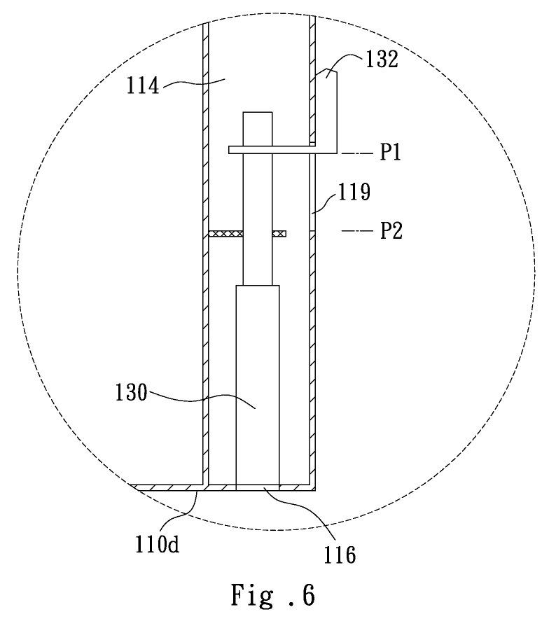

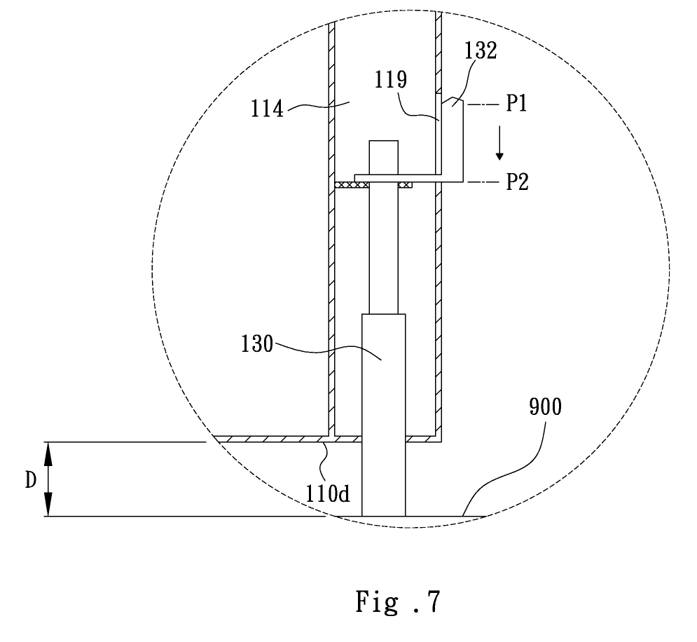

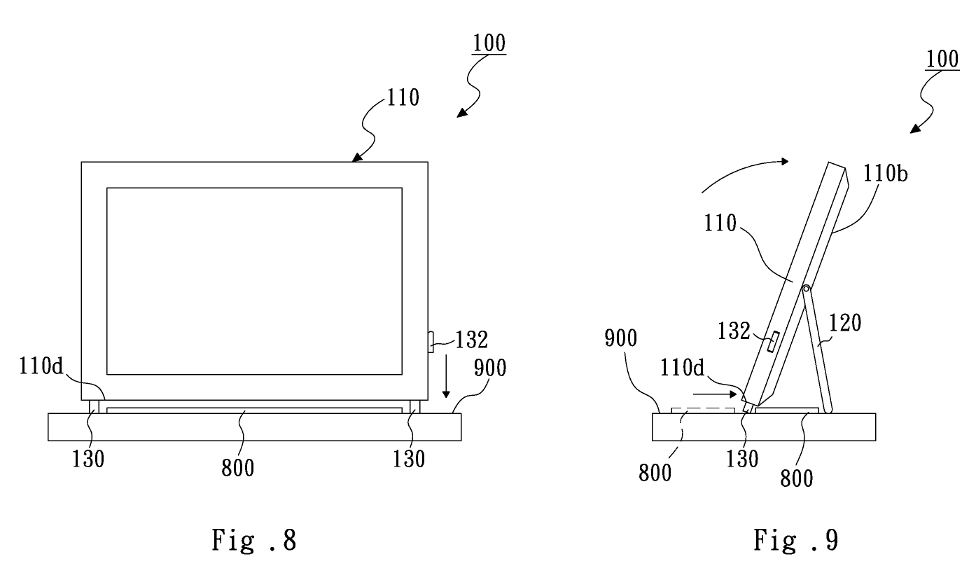

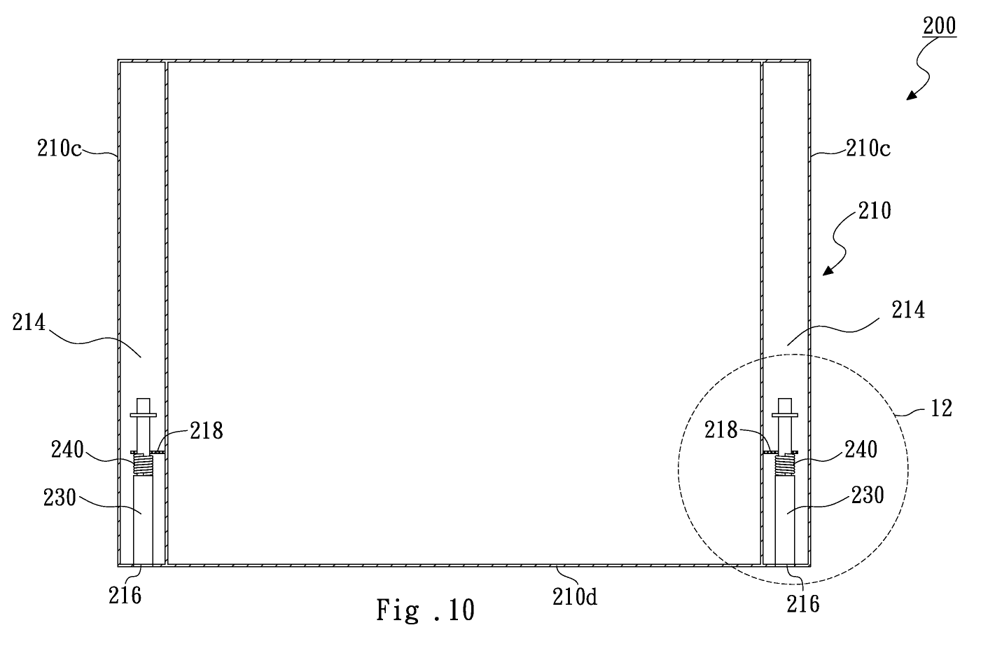

Referring to FIGS. 2, 8, and 9, when the flat panel display 100 is in use, the operating portions 132 may be operated by the user's hands to force the struts 130 to move from the contained position P1 to the support position P2 (as shown in FIGS. 6 and 7), such that the struts 130 are protruded out of the body 110 to lift the body 110 above the placement plane 900, thereby forming the supporting height D between the bottom edge 110d of the body 110 and the placement plane 900. Meanwhile, upon being rotated, the stand 120 may form an included angle θ₁ with respect to the back surface 110b of the body 110, such that the body 110 is prevented from falling backwards, but forms an inclined angle θ₂ (as shown in FIG. 5) with respect to the placement plane 900. A distance between the two struts 130 is larger than a width of a keyboard 800. Therefore, when the user no longer using the keyboard 800, he/she may moves the keyboard 800 to pass through a space between the two struts 130, that is, move the keyboard 800 to pass through the bottom edge 110d of the body 110, and then the keyboard 800 is stored below the body 110, such that the keyboard 800 does not occupy area on the placement plane 900.

Referring to FIGS. 4 and 6, when the flat panel display 100 is not in use, the struts 130 may be accommodated in the chambers 114 of the body 110, and the stand 120 may be rotated to lean against the back surface 110b of the body 110. Therefore, the flat panel display 100 combined with the struts 130 and the stand 120 does not have protruding or dismountable components disposed thereon, thereby simplifying the package structure and reducing the required package materials.

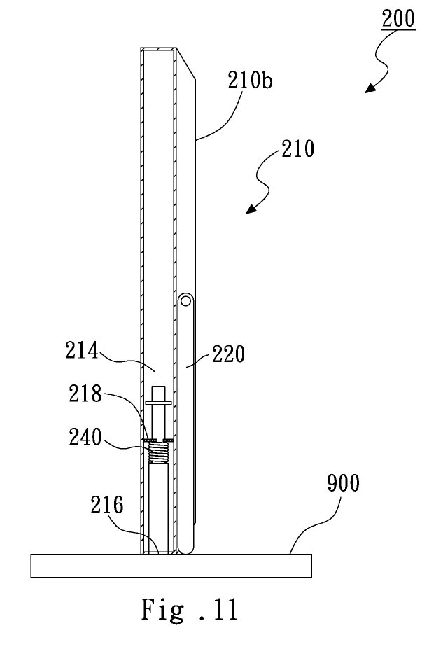

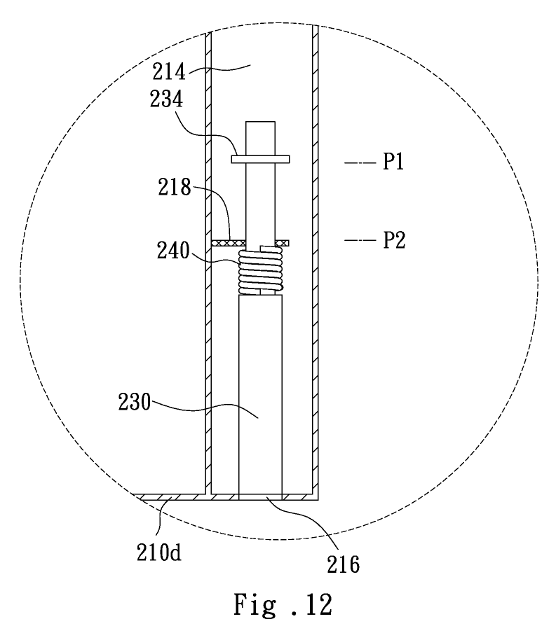

Referring to FIGS. 10 and 11, a flat panel display 200 using a retractable support according to a second embodiment of the present invention is shown; the display 200 includes a body 210, a stand 220, two struts 230, and two elastic members 240.

Referring to FIG. 10, the body 210 has two chambers 214 defined therein and the two chambers 214 are respectively corresponding to two opposite side edges 210c of the body 210. The body 210 has two openings 216, disposed on a bottom edge 210d of the body 210, and the two opening 216 respectively communicate the two chambers 214 with the exterior of the body 210. The stand 220 is pivoted on a back surface 210b of the body 210 of the display 200. The stand 220 is provided for being rotated to form an included angle with respect to the back surface 210b of the body 210, and a free end of the stand 220 bears against the placement plane 900 to support the body 210.

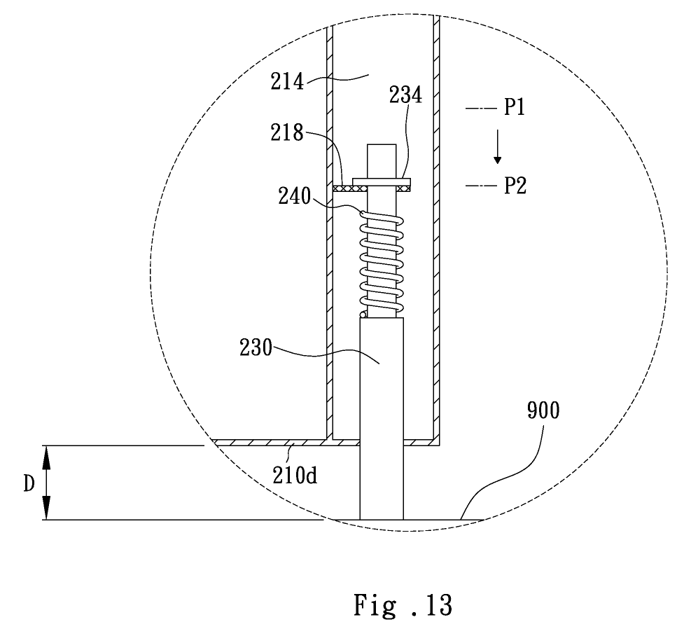

Referring to FIGS. 10, 11, 12, and 13, each strut 230 is movably disposed in the body 210. Each strut 230 is inserted in to one of the chamber 214 via the corresponding opening 216. And the strut 230 is provided for being moved between a contained position P1 and a support position P2. When each strut 230 is moved to the support position P2, the strut 230 supports the body 210, and a distance D is formed between the bottom edge 210d of the body 210 and the placement plane 900.

Referring to FIGS. 10, 11, 12, and 13, the two elastic members 240 are respectively disposed in one of the chambers 214 of the body 210 and corresponding to the two struts 230. The elastic members 240 bear against the body 210 and the struts 230, so as to force the struts 230 to move relative to the body 210 from the contained position P1 to the support position P2. The body 210 has two stoppers 218 respectively disposed in the chambers 214 of the body 210 of the display 200 corresponding to the two struts 230, and the struts 230 run through the stoppers 218 respectively. Each elastic member 240 is a compression spring sleeved on the corresponding strut 230. Two ends of each elastic member 240 respectively bear against the corresponding stopper 218 of the body 210 and the corresponding strut 230, thereby pushing the strut 230 to move from the contained position P1 to the support position P2.

In addition, each strut 230 includes at least one rib 234 formed on an outer peripheral surface of the strut 230. The rib 234 may be a single structure, and continuously surrounds the outer peripheral surface of the strut 230, or a plurality of ribs 234 is formed on the outer peripheral surface and located on the same radial cross-section of the strut 230. The rib 234 is stopped by the corresponding stopper 218, so that a limit position for the strut 230 to move outwards is restricted at the support position P2. Therefore, when moved to the support position P2, the strut 230 cannot further move towards the exterior of the body 210 any more, thereby preventing the strut 230 from protrude out from the opening 216.

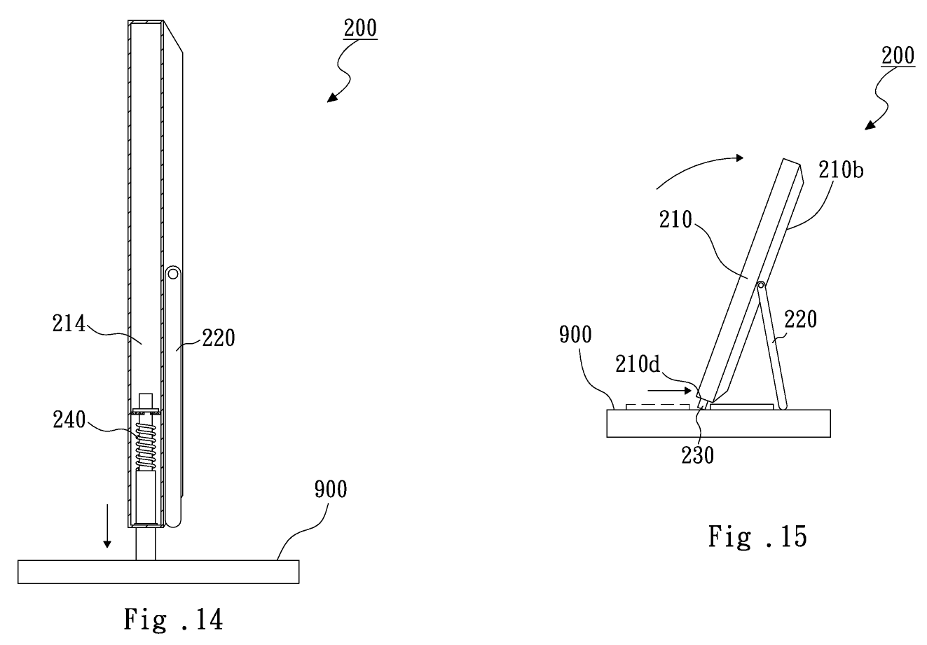

Referring to FIGS. 14 and 15, when the flat panel display 200 is lifted by the user, the bottom edge 210d is made to no longer contact the placement plane 900, and the ends of the struts 230 are not stopped by the placement plane 900. In this case, the struts 230 are protruded towards the exterior of the body 210 under an elastic force of the elastic members 240, so as to reach the support position P2, thereby forming a supporting height D between the bottom edge 210d of the body 210 and the placement plane 900. Upon being rotated, the stand 220 supports the back surface 210b of the body 210, such that the body 210 is prevented from falling backwards, but forms an included angle with respect to the placement plane 900.

According to different inclined angles, the weight of the body 210 is divided into different component force applied on the elastic members 240 for pushing the struts 230. Therefore, as long as a minimum included angle between the body 210 of the display 200 in use and a geographic vertical line is determined, the minimum elastic force required by the elastic members 240 can be estimated, such that the struts 230 do not retract due to the weight of the body 210. When the flat panel display 100 is not in use, the body 210 is in an upright state, or external package materials are used for stopping the struts 230, thereby maintaining the struts 230 within the chambers 214.

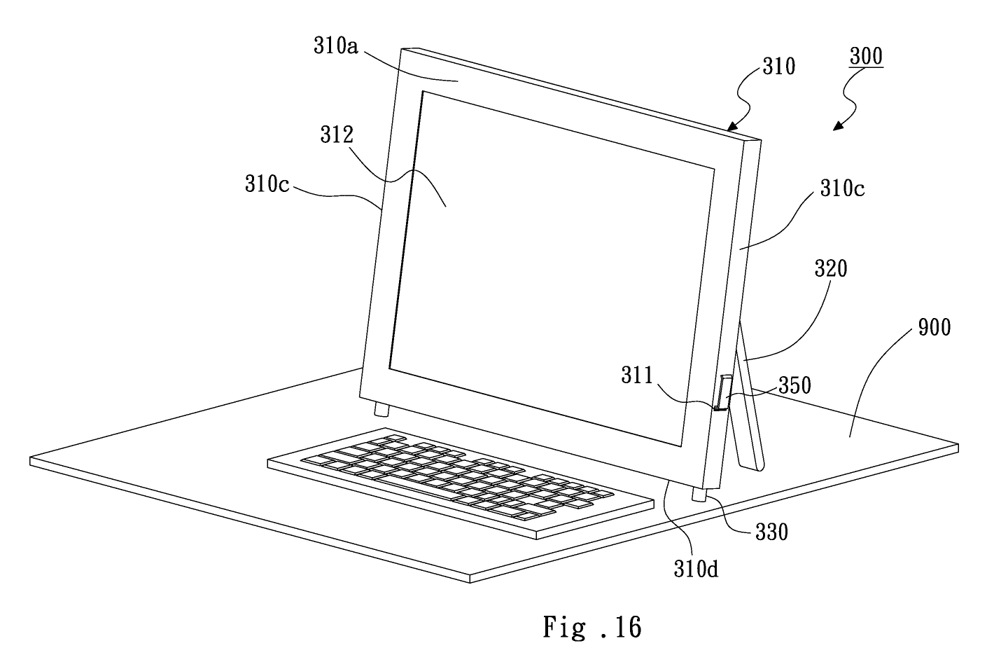

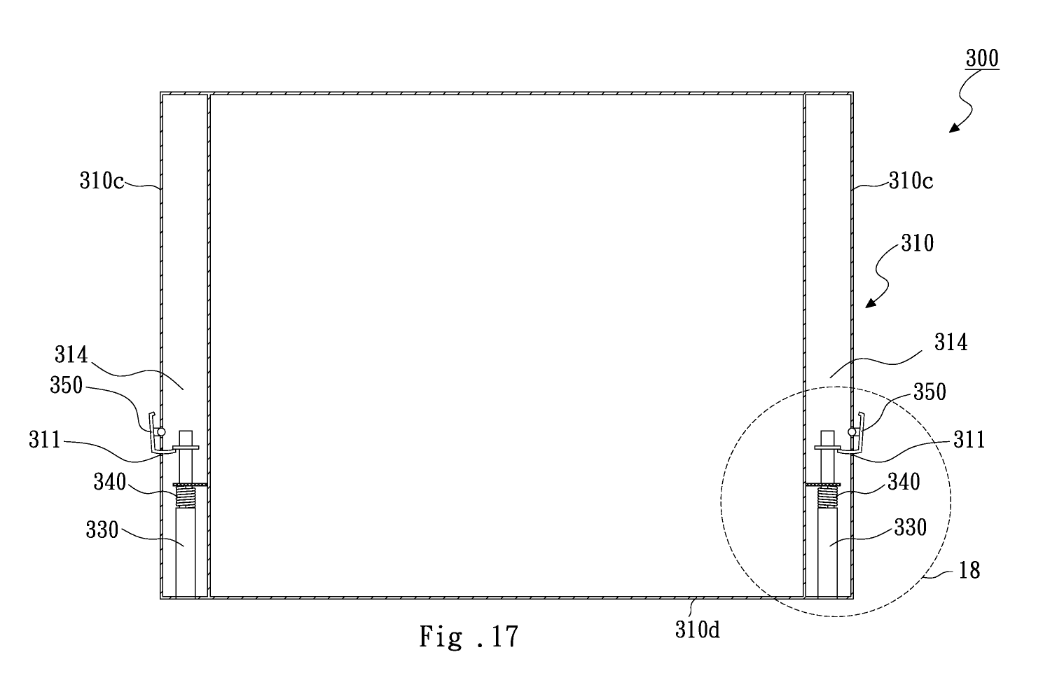

Referring to FIGS. 16, 17, 18, 19, and 20, a flat panel display 300 having a retractable support according to a third embodiment of the present invention is shown; the display 300 includes a body 310, a stand 320, two struts 330, two elastic members 340, and two latches 350. The details and connections of the body 310, the stand 320, the two struts 330, and the two elastic members 340 are substantially the same as those of the second embodiment.

Referring to FIGS. 17, 18, 19, and 20, the body 310 further includes two through holes 311 disposed on two side edges 310c of the body 310, and the two holes 311 communicate the chambers 314 with the exterior of the body 310. Meanwhile, when each strut 330 is moved to the contained position P1, a rib 334 of the strut 330 corresponds to the through hole 311. The two latches 350 are respectively disposed to the body 310 corresponding to the two struts 350. Each latch 350 respectively has a pressed end 352 and a latching end 354, and a middle section of the latch 350 is pivoted to a side edge 310c of the body 310. Once the pressed ends 352 are operated and released by the user' hands, the latches 350 swing relative to the body 310 like a seesaw, so that the latching ends 354 run through the through holes 311 to enter the chambers 314, or withdraw from the through holes 311 and are located on the exterior of the body 310.

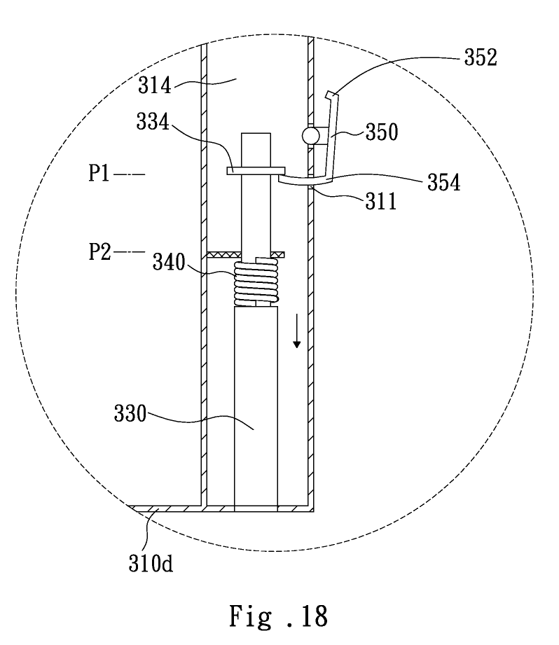

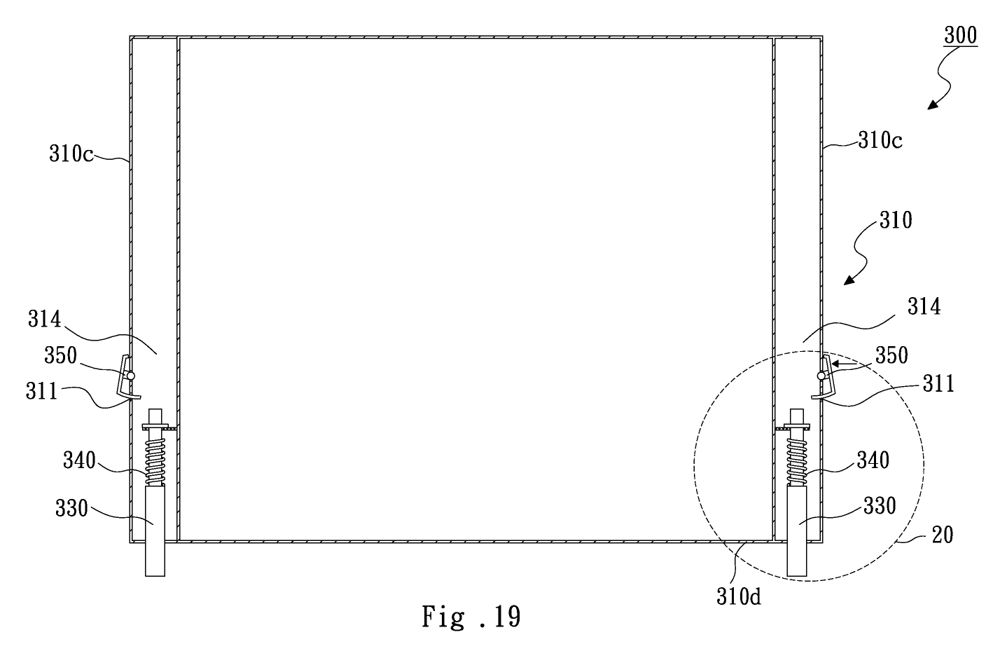

Referring to FIGS. 17 and 18, when each strut 330 is moved to the contained position P1, the latching end 354 runs through the through hole 311 and latches the rib 334 of the strut 330, thereby fixing the strut 330 at the contained position P1.

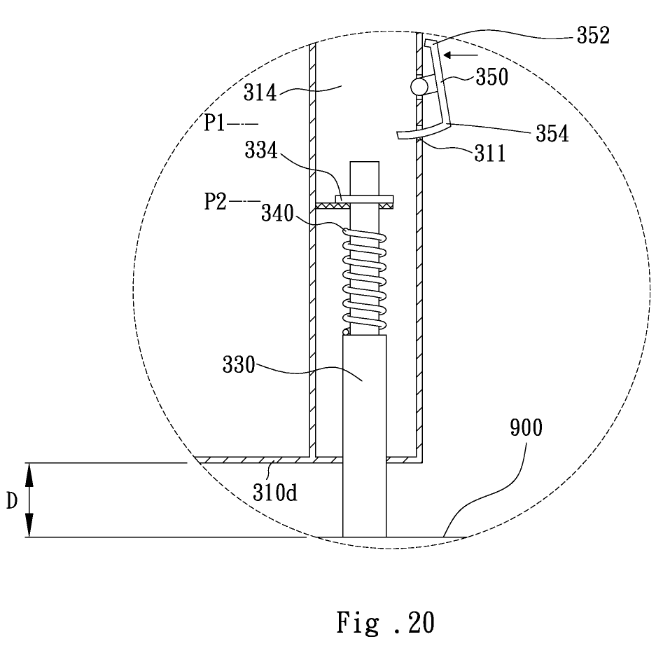

Referring to FIGS. 19 and 20, when the flat panel display 300 is lifted up by the user and the bottom edge 310d is made to no longer contact the placement plane 900, the pressed ends 352 of the latches 350 are pressed by the user, so as to force the latching ends 354 to withdraw from the through holes 311. In this case, the ribs 334 of the struts 330 are released by the latches 350, and the struts 330 are force to move to the exterior of the body 310 under the elastic force of the elastic members 340 and reach the support position P2, thereby forming a supporting height D between the bottom edge 310d of the body 310 and the placement plane 900.

What is claimed is:

1. A retractable support for supporting a display, the retractable support comprising:
a stand, pivoted to a back surface of the display, for being rotated to form an included angle with respect to the back surface of the display; and
two struts, movably disposed inside the display, for being moved between a contained position at which the strut is contained inside the display and a support position at which at least part of the strut is protruded out of the display.

2. The retractable support as claimed in claim 1, wherein each of the struts is connected to an operating portion disposed on the side of the display, and the operating portion runs through a slot of the display to be connected to the strut.

3. The retractable support as claimed in claim 1, further comprising two elastic members, disposed in the display corresponding to the two struts, for pushing the struts to move relative to the display from the contained position to the support position.

4. The retractable support as claimed in claim 3, wherein each of the elastic members is a compression spring sleeved on the corresponding strut.

5. The retractable support as claimed in claim 3, further comprising two stoppers, disposed in the display and corresponding to the two struts respectively, and each of the struts including at least one rib for being stopped by the corresponding stopper, such that a limit position for each strut to move outward is restricted at the support position.

6. The retractable support as claimed in claim 5, further comprising two latches disposed to the display corresponding to the two struts respectively, for latching the ribs of the struts and fixing the struts at the contained position.

7. The retractable support as claimed in claim 6, wherein each of the latches is pivoted to the display and has a pressed end for being operated and a latching end for latching the rib of the corresponding strut.

8. The retractable support as claimed in claim 3, further comprising two latches disposed to the display and corresponding to the two struts, for fixing each of the struts at the contained position.

9. The retractable support as claimed in claim 8, wherein each of the latches is pivoted to the display and has a pressed end for being operated and a latching end for latching the corresponding strut.

10. A display having a retractable support, comprising:
a body, having a display panel disposed on a front surface of the body, and having two chambers and two openings, wherein the chambers are defined in the body, and the two openings respectively communicate the two chambers with an exterior of the body; and
two struts, movably inserted into the two chambers respectively via the corresponding openings, for being moved between a contained position to be accommodated in the corresponding chambers and a support position at which at least one part of each of the struts is protruded out of the body.

11. The display as claimed in claim 10, further comprising a stand, pivoted to a back surface of the body, for being rotated to form an included angle with respect to the back surface of the body.

12. The display as claimed in claim 10, further comprising two operating portions, disposed on the side of the body and connected to each of the struts.

13. The display as claimed in claim 12, wherein the body includes two slots formed thereon, respectively communicating the two chambers with an exterior of the body, and each of the operating portions respectively is connected to each of the struts through each of the slots.

14. The display as claimed in claim 10, further comprising two elastic members, disposed in the two chambers respectively and corresponding to the two struts, for pushing the struts to move relative to the display from the contained position to the support position.

15. The display as claimed in claim 14, wherein the body includes two stoppers, respectively disposed in the two chambers, and two ends of each of the elastic members respectively bear against one of the stoppers and the corresponding strut.

16. The display as claimed in claim 15, wherein each of the struts respectively includes at least one rib for being stopped by the corresponding stopper, such that a limit position for each the strut to move outwards is restricted at the support position.

17. The display as claimed in claim 15, further comprising two latches, disposed to the body corresponding to the two struts respectively, for latching the ribs of the struts and fixing the struts at the contained position.

18. The display as claimed in claim 17, wherein each of the latches is pivoted to the body and a pressed end for being operated and a latching end for latching the rib of the corresponding strut.

19. The display as claimed in claim 14, further comprising two latches disposed to the display and corresponding to the two struts, for fixing each of the struts at the contained position.

20. The display as claimed in claim 19, wherein each of the latches is pivoted to the body and has a pressed end for being operated and a latching end for latching the corresponding strut.
